(19) United States
(12) Patent Application Publication
(10) Pub. No.: US 2006/0162310 A1
(43) Pub. Date: Jul. 27, 2006

(54) Mulcher blade

(75) Inventor: John Dittmer, Jasper, IN (US)

Correspondence Address: MCANDREWS HELD & MALLOY, LTD, 500 WEST MADISON STREET, SUITE 3400, CHICAGO, IL, 60661, US

(73) Assignee: Stens Corporation

(21) Appl. No.: 11/326,753

(22) Filed: Jan. 6, 2006

Related U.S. Application Data
(63) Continuation of application No. 11/041,788, filed on Jan. 21, 2005.

(51) Int. Cl. A01D 34/13; A01D 34/40

(52) U.S. Cl. 56/289

(57) ABSTRACT

The present invention relates to a mulching rotary lawn mower blade and a method of mulching grass using a mulching rotary lawn mower blade. The mulching rotary lawn mower blade comprises a mounting section adapted to be attached to a lawn mower motor drive shaft and first and second sections extending respectively further outward from the mounting section and being respectively pitched upwardly and downwardly. First and second cutting surfaces are formed along at least a portion of at least one of the first and second surfaces. The first cutting surface is adapted to form grass clippings, while the second cutting surface has at least one cutout and is adapted to cut the grass clippings. The first cutting surface passes the grass clippings to the second cutting surface which recuts the grass clippings as the grass clippings pass through the cutout.

### BACKGROUND OF THE INVENTION

The present invention relates generally to lawn mower blades and more particularly to improved mulching rotary lawn mower blades used with rotary lawn mowers.

One or more embodiments are especially suitable for use in converting a bagging or side discharge rotary lawn mower into a mulching mower which repeatedly cuts and comminuties clippings and distributes them back into the grass at soil level, forming mulch.

Environmental concerns, particularly reduced landfill capacity, has resulted in some communities precluding the disposal of grass clippings in landfills. Mulching lawn mowers have heretofore been proposed. See, for example, U.S. Pat. Nos. 4,189,903 issued Feb. 26, 1980 and 4,205,512 issued Jun. 3, 1980 to Jackson et al. and Thorud, respectively, each of which is incorporated herein by reference in their entirety. However, such known mulching lawn mowers are expensive in comparison to currently available bagging or side discharge rotary lawn mowers. It is desirable that the needed finely distributed clippings be provided by the operation of the lawn mower blade without requiring special baffles or vanes in the lawn mower housing. Previous mulching blade designs having up-pumping sections, which lift cut grass at the outsides thereof, and down-pumping sections, which push recut grass downwardly towards the ground. Such known blades are, however, subject to clogging and producing undesired clumps.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

The present invention relates to a mulching rotary lawn mower blade and a method of mulching grass using a mulching rotary lawn mower blade. The mulching rotary lawn mower blade comprises a mounting section adapted to be attached to a lawn mower motor drive shaft and first and second sections extending respectively further outward from the mounting section and being respectively pitched upwardly and downwardly. First and second cutting surfaces are formed along at least a portion of at least one of the first and second surfaces. The first cutting surface is adapted to form grass clippings, while the second cutting surface has at least one cutout and is adapted to cut the grass clippings. The first cutting surface passes the grass clippings to the second cutting surface which recuts the grass clippings as the grass clippings pass through the cutout.

Other embodiments of the blade are contemplated. For example, the first section of the blade may extend outwardly and downwardly from the mounting section and the second section extend outwardly and upwardly from the first section, or the first section may extend outwardly and upwardly from the mounting section and the second section extend outwardly and downwardly from the first section. It is contemplated that the first cutting surface may comprise a cutting edge extending along at least a portion of both the first and second sections, along at least one side thereof.

In at least one embodiment, the blade may be formed with a tip at a distal end thereof defining an end of the second section. The tip is formed having corners opposite the cutting edge, the corners being tilted upwardly or bent to define at least one wing proximate the at least one cutout. In certain embodiments, the blade is bent or formed about a bend line, where the bend line is defined at about 30 degrees with respect to one edge of the blade. Additionally, the tip may be formed where the corners define a plurality of wings proximate a plurality of cutouts, where a pair of wings define at least one cutout.

It is contemplated that at least one but generally all the cutouts have at least one cutting edge. Further, first cutting surface passes the grass clippings to the second cutting surface.

Another embodiment relates to mulching rotary lawn mower blade. This embodiment comprises a central mounting section adapted to be attached to a lawn mower motor drive shaft and two first sections, each of the first sections extends outwardly from opposing sides of the central mounting section and pitched upwardly therefrom. Two second sections extend extending outwardly from one of the first sections and are pitched downwardly therefrom. The blade further comprises a cutting edge extending along one side of at least a portion of both the first and second sections and forming a first cutting surface. A plurality of wings are formed proximate a tip of each of the second sections, the plurality of wings defining at least one cutout and forming a second cutting surface, wherein the first cutting surface cuts grass forming grass clippings and passes the grass clippings to the second cutting surface which recuts the grass clippings as the grass clippings pass through the at least one cutouts. Still another embodiment of the invention relates to a method for mulching grass using a mulching rotary lawn mower blade. In this embodiment, the method comprises cutting grass blades using a first cutting surface, forming grass clippings. The method further comprises recutting the grass clippings using the second cutting surface forming mulch. In at least one embodiment of the method, the grass clippings are passed to the second cutting surface (by the first cutting surface for example). The grass clippings pass though through the at least one cutout, where the clippings are recut, forming fine mulch.

### BRIEF DESCRIPTION OF SEVERAL VIEWS OF THE DRAWINGS

FIG. 1 depicts a perspective view of a prior design mulching rotary lawn mower blade;

FIG. 2 depicts a top plan view of an improved mulching rotary lawn mower blade in accordance with embodiments;

FIG. 3 depicts a bottom plan view of the mulching rotary blade illustrated in FIG. 2;

FIG. 4 depicts a side elevational view of the mulching rotary blade illustrated in FIG. 2;

FIG. 5 depicts a sectional view of the mulching rotary blade illustrated in FIG. 2 taken along line 5-5;

FIG. 6 depicts a sectional view of the mulching lawnmower blade illustrated in FIG. 2 taken along line 6-6;

FIG. 7 depicts a high-level flow diagram illustrating a method of forming mulched grass using an improved mulching rotary lawn blade illustrated in FIGS. 2-6 above; and

FIG. 8 depicts a detailed flow diagram illustrating a method of forming mulched grass (similar to that of FIG. 7) using an improved mulching rotary lawn blade illustrated in FIGS. 2-6 above.

### DETAILED DESCRIPTION OF THE INVENTION

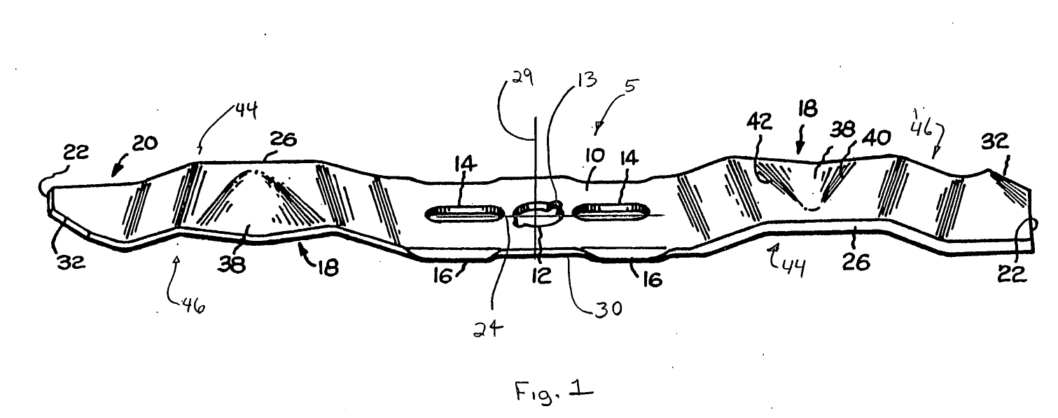

Referring more particularly to the drawings, FIG. 1 illustrates a prior design mulching rotary lawn mower blade 5 having a mounting section, portion or area 10 with a center hole 12 of universal design as disclosed in U.S. Pat. No. 5,094,065 incorporated herein by reference in its entirety. In at least one embodiment, blade 5 is adapted to be received in most lawn mowers having the blade mounted on the motor drive shaft within the housing of the lawn mower. The housing generally has a skirt along the side thereof with at least one opening through which grass is normally discharged. During mulching operations, a mulching door is preferably used to close or secure the opening. The door may have a matrix of holes which contain the grass while releasing air pressure during mulching operations. It should be appreciated that while the lawn mower, its housing and the door are not shown, they are conventional and well known in the art. Examples of such lawn mower, housing and door are provided in the patents cited previously.

In at least one embodiment, the center hole 12 has one or more ears 13 for receiving drive lugs and one or more side slots 14 in which other drive lugs may be used if the lawn mower is so equipped. The mounting portion 10 may include one or more lips 16 for strengthening purposes. It should be appreciated that area of mounting portion 10 may be increased or reduced in diameter depending upon the size of blade 5. For example, a 22-inch blade may have a 6-inch diameter mounting portion (3 inches on either side of the axis of rotation or center hole 12). An 18-inch blade may only have a 2 inch diameter mounting portion (1 inch on either side of the axis of rotation or center hole 12).

First or inner and second or outer sections 18 and 20 respectively, are depicted extending from mounting area 10. These sections may each be approximately 4 inches in diameter for example. Each of the first sections 18 extends from opposing sides or ends of mounting portion 10 to second section 20. Each of the second sections 20 extends from first section 18 to the tip (i.e., opposing ends 22). It is contemplated that blade 5 may have symmetrical first and second sections 18 and 20, although in principal sections 18 and 20 may not be symmetrical and/or only a part of the blade 5 on one side of sections 18 and/or 20 (along one radius) need be designed for cutting purposes.

In at least one exemplary embodiment, blade 5 is formed by pressing from a strip of steel (e.g. cold rolled steel). In this embodiment, blade 5 is comprised of Type 1065 steel having a hardness of R-C-35-40. The blade is 0.135 inches thick by 2 inches wide. Longitudinal center line 24 extends along the middle of the width of blade 5 and is perpendicular to the lateral center line 29 which extends between the opposite ends 22. The axis of rotation is at the intersection of these center lines 24 and 29 (i.e., hole 12).

Blade 5 has one or more cutting edges 26 which extend from opposing tips 22 over at least a portion but generally the entire length of at least one but generally both the first and second sections 18 and 20 (along at least one side). In the illustrated embodiment, cutting edges 26 are formed on opposing sides of blade 5, although other embodiments are contemplated. The cutting edges 26 are made by milling a bevel across the first and second sections 18 and 20 along a leading edge 44 of blade 5 before the blade is formed so that the second sections 20 are pitched upwardly from leading edge 40 (the cutting edge 26) to the lagging edge 46 opposite cutting edge 26. First section 18 is pitched in the opposite direction downwardly from the cutting edge 26 to lagging edge 46. Accordingly, second section 20 acts in an up-pumping fashion, providing an upwardly flowing air stream adapted to lift the clippings, while the first section 18 acts in a down-pumping fashion, pushing or blowing clippings towards the ground. In at least one embodiment, the angle of inclination of the second section 20 is about 16 degrees with respect to the horizontal, while the inclination of the first section 18 is less than the inclination of the second section 20, about 12 degrees with respect to the horizontal for example. All measurements are made with respect to a generally horizontal plane defined by surface 30 on the bottom of the mounting section 10.

FIG. 1 illustrates each end 22 is formed with a sail 32 at least one corner. In one embodiment, sail 32 is formed in a corner of end 22 opposite to cutting edge 16. Sails 32 provide a further inclination in two steps, with a 9 degree first step and 53 degree second step with respect to the horizontal, although more steps and different inclinations are contemplated. The sails 32 are adapted to further lift the clippings, moving them inwardly towards first section 18 for multiple cuts by the blade 26 in the first section 18, forming a fine mulch.

In at least one exemplary embodiment of blade 5, first section 18 includes at least one trough or tunnel 38. It should be appreciated that the inclination of first section 18, alone or with the trough or tunnel 38, clears clippings from the leading to lagging edges of the first section 18 along a bisecting line. Although one trough is discussed, more than one trough is contemplated. For example, FIG. 1 illustrates two troughs.

The trough or tunnel 38 comprises a dip which is adapted to keep clippings suspended for multiple cuts by creating a tunnel of moving air. The pressure created by the tunnel of moving air directs the clippings downwardly in a wide swath, distributing them into the grass at soil level. Sides 40 and 42 of the trough 38 are generally curved and form a triangular shape. The center line through trough 38 is inclined downwardly. The troughs are much deeper in the rear at lagging edge 46 than at leading edge 44. The trough 38 may have a forward region 39 (proximate leading edge 44) and a rearward region 41 (proximate lagging edge 46) which are inclined at greater angles with respect to the horizontal, about 4 degrees and 11 degrees, respectively for example.

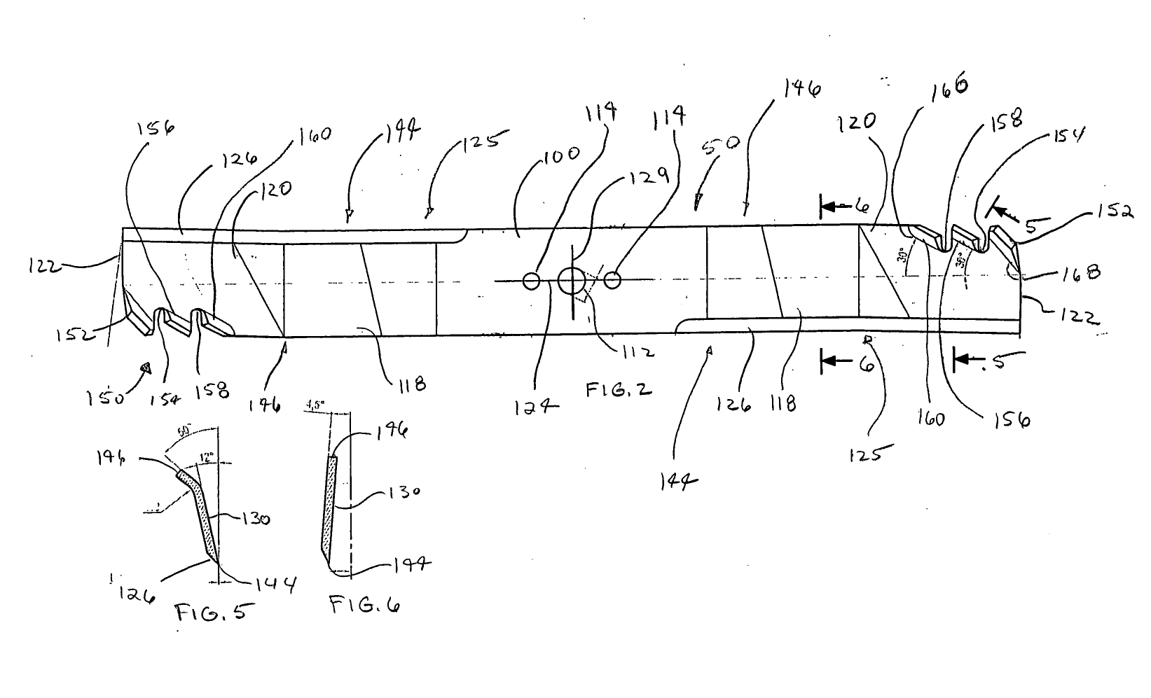

Referring to the drawings, FIGS. 2-6 illustrate a mulching rotary lawn mower blade 50 having a mounting section, portion or area 100 (a central mounting section for example) with a hole 112 of universal design. This embodiment of blade 50 is adapted to be received in most lawn mowers having blade 50 mounted (removably mounted for example) on the motor drive shaft within the housing of the lawn mower as provided previously.

In the embodiment illustrated in FIGS. 2 and 3, the center hole 112 has one or more side holes 114 in which other drive lugs may be used if the lawn mower is so equipped. It should be appreciated that mounting section 100 may be increased or reduced in diameter depending upon the size of the blade. For example, 20.5 and 21-inch blades may have a mounting area between about 7 and about 8 inches in diameter while 24 and 24.5-inch blades may have a mounting area between about 9 and about 10 inches in diameter (examples are provided in Table 1 below). It should be appreciated that, while only 20.5, 21, 24 and 24.5 inch blades are shown in Table 1 and discussed, other blade sizes (16, 16.5, 17, 17.5, 18, 18.5, 19, 19.5, 20, 21.5, 22, 22.5, 23 and 23.5 inches for example) are contemplated.

First or inner and second or outer sections 118 and 120 respectively, are depicted extending outwardly from at least one but generally both sides of the mounting section 100. These sections may each be between about 0.1 and 0.3 inches thick and between about 1 and about 3 inches wide (about 0.204 inches thick and about 2.50 inches wide for example). At least one but generally both of the second sections 120 extend to the tip at opposing ends 122 of blade 50. It is contemplated that blade 50 may have symmetrical first and second sections 118 and 120, although in principal only one side of the blade (along one radius for example) need be designed for cutting purposes. It is further contemplated that the first sections 118 of blade 50 may be between about 9 and about 10 inches in diameter and the second sections 120 may be between about 4 and about 5 inches in diameter (examples are provided in Table 1 below).

TABLE 1

| | | Mounting | | First | | Second |
|---|---|---|---|---|---|---|
| | | Area | | Section | | Section |
| | Total | Length | | Length | | Length |
| | Mount- | on One | Total | on One | Total | on One |
| Total | ing | Side of | First | Side of | Second | Side of |
| Blade | Area | Axis of | Section | Axis of | Section | Axis of |
| Length | Length | Rotation | Length | Rotation | Length | Rotation |
| (Inches) | (Inches) | (Inches) | (Inches) | (Inches) | (Inches) | (Inches) |
| 20.5 | 6.262 | 3.146 | 9.620 | 4.81 | 4.618 | 2.309 |
| 21 | 6.262 | 3.146 | 9.620 | 4.81 | 5.118 | 2.559 |
| 24 | 9.792 | 4.795 | 9.59 | 4.795 | 4.618 | 2.309 |
| 24.5 | 9.792 | 4.795 | 9.59 | 4.759 | 5.118 | 2.559 |

In at least one exemplary embodiment, blade 50 is formed by pressing from a strip of steel (e.g. cold rolled steel). In this embodiment, blade 50 is formed of boron steel (having a hardness of HRC 43-47 for example) which is about 0.135 to 2 inches thick by about 2 to 3 inches wide. Blade 50 is formed having longitudinal center line 124 extending along the middle of the width of the blade and perpendicular to the lateral center line 129 which extends between the opposite edges of blade 50. The axis of rotation is at the intersection of these center lines 124 and 129 (i.e., hole 112).

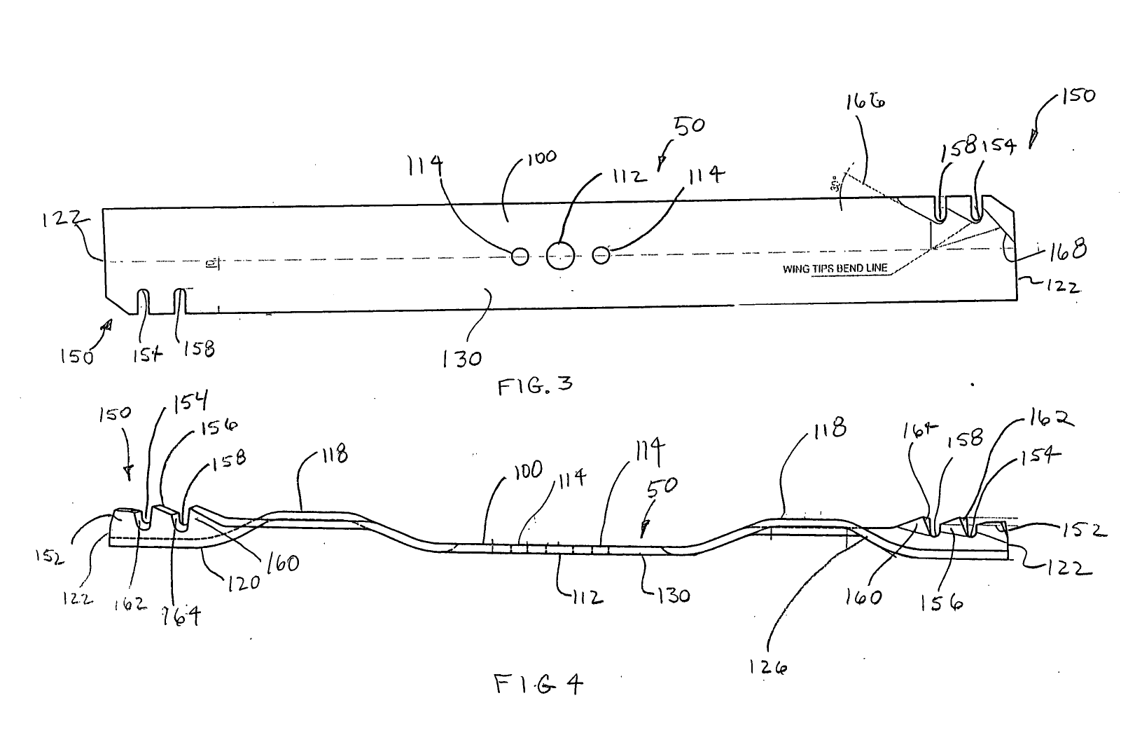

FIGS. 2 and 4 depict blade 50 having at least first and second cutting surfaces 125 and 150 respectively. In at least one embodiment, first cutting surface 125 comprises one or more cutting edges 126 extending from opposing tips 122 over at least a portion of, but generally the entire length of, at least one but generally both first and second sections 118 and 120 (along at least one side for example). In the illustrated embodiment, cutting edges 126 are formed on opposing sides of blade 50, although other embodiments are contemplated.

Cutting edges 126 are made by milling a bevel across first and second sections 118 and 120 along a leading edge 144 of blade 50 before the blade is formed, so that the second sections 120 are pitched generally upwardly from leading edge 140 (the cutting edge 126) to the lagging edge 146 opposite cutting edge 126 (best viewed in FIG. 5). In at least one embodiment, first section 118 is pitched in the opposite direction, generally downwardly from the cutting edge 126 to lagging edge 146 (best viewed in FIG. 6). Accordingly, second section 120 acts in a generally up-pumping fashion, providing an upwardly flowing air stream adapted to lift the clippings, while the first section 118 acts in a generally down-pumping fashion, pushing or blowing clippings towards the ground. In at least one embodiment, the angle of inclination of the second section 120 is greater than the angle of inclination of the first section 118.

In one exemplary embodiment, second cutting surface 150 comprises at least one cutout having at least one cutting edge. FIGS. 2-4 illustrate at least one wing is formed proximate at least one but generally both ends 122. In one embodiment, three sets of wings (152, 156 and 160) are formed in the corner of each end 122 opposite cutting edge 126 (in lagging edge 146). In this embodiment, a pair of wings define at least one cutout. For example, wing pair 152 and 156 define cutout 154 while wing pair 156 and 160 define cutout 158. It should be appreciated that while three sets of wings and two cutouts are illustrated, other arrangements including a different apportionment of wings to cutouts is contemplated. Each cutout is formed having at least one cutting edge (by milling a bevel in the cutouts for example). Cutouts 154 are formed having cutting edge 162 while cutouts 158 are formed having cutting edge 166.

Wings 152, 156 and 158 (and at least a portion of outer section 120) are formed having an inclination in two steps (best illustrated in FIG. 5 taken along line 5-5 of FIG. 1) Second section 120 is formed having about a 12 degree inclination, (defined with respect to the horizontal plane defined by surface 130 on the bottom of the mounting section 100), while the wings are formed at about a 50 degree second step with respect to the horizontal. Thus, the wings are formed with about a 12 degree first step and about a 50 degree second step, although more steps and different inclinations are contemplated. The wings are formed about wing tip bend line 166 (best viewed in FIG. 3), where wing tip bend line is formed at about 30 degrees with respect to one edge (lagging edge 146 for example). However, in at least one embodiment, the wings may be formed about two wing tip bend lines 166 and 168, where wing tip bend line 168 is formed at about 50.6 degrees with respect to one edge. The wings are formed or bent with respect to at least one or both wing tip bend lines 166 and 168 (where at least one wing is formed about wing tip bend line 166 and at least one wing is formed about wing tip bend line 168 for example), having the two step inclination described previously. In at least one embodiment, the wings may enable the clippings to be pushed towards the ground oray further lift the clippings after passing through the cut outs, moving the clippings inwardly towards first section 118 for multiple cuts by the cutting edge 126, forming a fine mulch.

As provided previously, first section 118 is pitched generally downwardly from the cutting edge 126 to lagging edge 146 (best viewed in FIG. 6 taken along line 6-6 of FIG. 1). In the illustrated embodiment, the angle of inclination of first section 118 is about 4.5 degrees with respect to the horizontal. First section is down-pumping and pushes or blows the clippings toward the ground. Unless noted, all measurements are made with respect to a generally horizontal plane which is defined by the surface 130 on the bottom of the mounting section 100 (see FIG. 3).

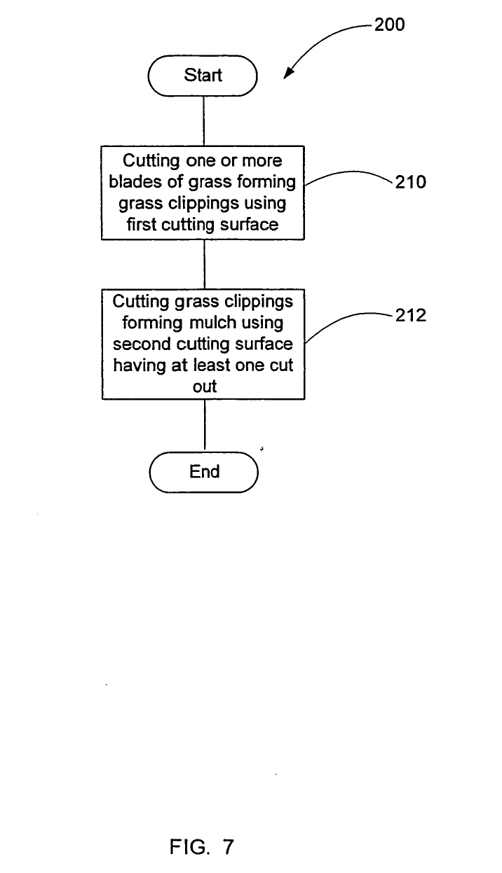

FIG. 7 depicts a high level flow diagram illustrating a method of mulching grass using a rotary lawn mower blade in accordance with certain embodiments. In at least one embodiment the method, generally designated 200, comprises block 210, cutting one or more blades of grass forming grass clipping using a first or initial cutting surface similar to that described previously. Method 200 further comprises block 212, cutting (i.e., recutting) the grass clippings using a second cutting surface having at least one cut out, forming the mulched grass.

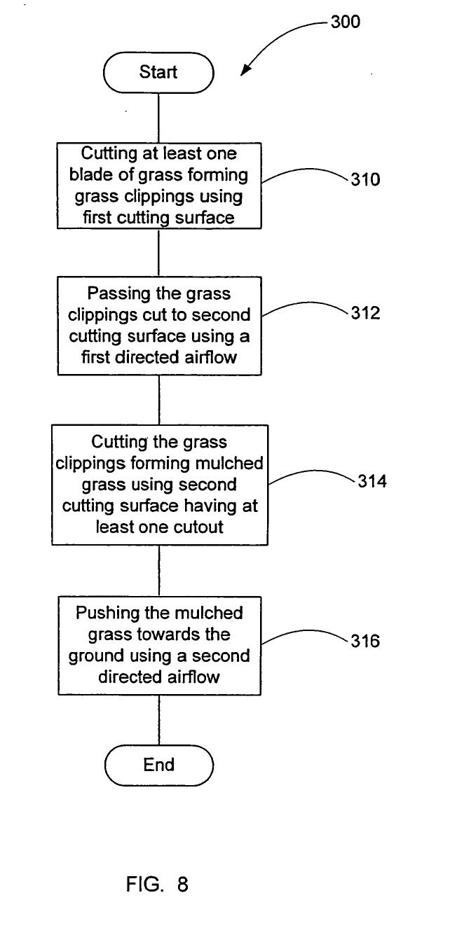

FIG. 8 depicts a detailed flow diagram illustrating a method of forming mulched grass (similar to that illustrated in FIG. 7) using a rotary lawn mower blade in accordance with certain embodiments. In at least one embodiment, the method, generally designated 300, comprises block 310, cutting at least one blade of grass forming one or more grass clippings using a first or initial cutting surface similar to that described previously. Method 300 further comprises block 312, passing the one or more grass clippings to the second cutting surface using at least a first directed airflow. In at least one embodiment, first section 118 acts in a generally downwardly fashion, passing the grass clippings to the second cutting surface using such a downwardly flowing air stream. However, embodiments are contemplated in which first section 118 acts in a generally upwardly fashion, passing the grass clippings to the second cutting surface using an upwardly flowing air stream.

FIG. 8 further depicts block 314, cutting the grass clippings forming mulched grass using second cutting surface having at least one cutout. In at least one embodiment, each of the cutouts are formed having at least one cutting edge (cutting edges 162 and 166 for example). The cutouts having at least one cutting edge perform multiple cuts, forming a fine mulch. Method 300 further comprises block 316, pushing the mulched grass towards the ground using a second directed airflow. In at least one embodiment, second section 120 acts in a generally upward fashion, providing an upwardly flowing air stream adapted to lift the mulched grass. The clippings may be pushed upward where, in at least one embodiment, the mulched grass may interact with the downwardly flowing air stream created by the first section 118, pushing the mulched grass towards the ground or back to the first cutting surface for further cutting. However, embodiments are contemplated in which second section 120 acts in a generally downwardly fashion.

Many modifications and variations of the present invention are possible in light of the above teachings. Thus, it is to be understood that, within the scope of the appended claims, the invention may be practiced otherwise than as described hereinabove.

1. A mulching rotary lawn mower blade, said blade comprising:
a mounting section adapted to be attached to a lawn mower motor drive shaft;
first and second sections extending respectively further outward from said mounting section and being respectively pitched upwardly and downwardly;
a first cutting surface formed along at least a portion of at least one of said first and second surfaces and adapted to form grass clippings; and
a second cutting surface formed along at least a portion of one of said first and second surfaces and having at least one cutout, wherein said second cutting surface cuts said grass clippings as said grass clippings pass through said cutout.

2. The blade of claim 1 wherein said first section extends outwardly and downwardly from said mounting section and said second section extends outwardly and upwardly from said first section.

3. The blade of claim 1 wherein said first section extends outwardly and upwardly from said mounting section and said second section extends outwardly and downwardly from said first section.

4. The blade of claim 1 wherein said first cutting surface comprises a cutting edge extending along at least a portion of both said first and second sections.

5. The blade of claim 4 wherein said first cutting surface comprises said cutting edge extending along at least one side of both said first and second sections.

6. The blade of claim 4 wherein said blade has a tip at a distal end thereof defining an end of said second section, said tip having a corner opposite said cutting edge, said corner being tilted upwardly to define at least one wing proximate said at least one cutout.

7. The blade of claim 6 wherein said corner define a plurality of wings proximate a plurality of cutouts.

8. The blade of claim 7 wherein a pair of wings define said at least one cutout.

9. The blade of claim 6 wherein said at least one wing is formed about a bend line.

10. The blade of claim 9 wherein said bend line is defined at 30 degrees with respect to one edge of the blade.

11. The blade of claim 1 wherein said cutout has at least one cutting edge.

12. The blade of claim 1 wherein said first cutting surface passes said grass clippings to said second cutting surface.

13. A mulching rotary lawn mower blade, said blade comprising:
a central mounting section adapted to be attached to a lawn mower motor drive shaft;
two first sections, each of said first sections extending outwardly from opposing sides of said central mounting section and pitched upwardly therefrom;
two second sections, each of said second sections extending outwardly from one of said first sections and pitched downwardly therefrom;
a cutting edge extending along one side of at least a portion of both said first and second sections and forming a first cutting surface; and
a plurality of wings formed proximate a tip of each of said second sections, said plurality of wings defining at least one cutout and forming a second cutting surface, wherein said first cutting surface cuts grass forming grass clippings and passes said grass clippings to said second cutting surface which recuts said grass clippings as said grass clippings pass through said at least one cutout.

14. The blade of claim 13 wherein said blade has a tip at a distal end thereof defining an end of said second section, said tip having corners opposite said cutting edge, said corners being tilted upwardly to define said plurality of wings.

15. The blade of claim 13 wherein said at least one wing is formed about a bend line defined about at a 30 degree angle with respect to one edge of the blade.

16. The blade of claim 13 wherein said cutout has at least one cutting edge.

17. A method for mulching grass using a mulching rotary lawn mower blade, said method comprising:
cutting grass blades using a first cutting surface, forming grass clippings; and
recutting said grass clippings using said second cutting surface forming mulch.

18. The method of claim 17 comprising passing said grass clippings to said second cutting surface.

19. The method of claim 18 wherein recutting said grass clippings comprises passing said grass clippings through said at least one cutout.

20. The method of claim 18 wherein said first cutting surface passes said grass clippings to said second cutting surface.
